(19) United States
(12) Patent Application Publication
(10) Pub. No.: US 2019/0174776 A1
(43) Pub. Date: Jun. 13, 2019

(54) NOVEL SCENE CAKE

(71) Applicant: Shanghai DuoTian Food Co., Ltd, Shanghai (CN)

(72) Inventor: Hongge FENG, Shanghai (CN)

(21) Appl. No.: 16/087,793

(22) PCT Filed: Jul. 17, 2018
(86) PCT No.: PCT/CN2018/095919

§ 371 Date: Sep. 24, 2018

(30) Foreign Application Priority Data
Jul. 17, 2017 (CN) 201720865379.1

(51) Int. Cl. A21D 13/48; A21D 13/47; A21D 13/80

(52) U.S. Cl. CPC A21D 13/48; A21D 13/80; A21D 13/47

(57) ABSTRACT

The utility model relates to the field of cakes, and particularly relates to a scene cake capable of being transported remotely, and can be produced in batches and can be stored for a long time. The scene cake comprises a cake body, an isolation layer and a scene layer, wherein the cake body, the isolation layer and the scene layer can be independently detached, and in the using state of the cake, the isolation layer is arranged on the cake body, and the scene layer is positioned on the isolation layer to form a complete cake. In the transportation state, the cake body is formed by wrapping a cold storage package body conforming to the long-distance transport requirements of cake food materials, the scene layer comprises various models including toys. The scene cake provided by the invention can carry out long-distance transportation and suitable for standardized batch production, and beneficial to commercial popularization, has certain commercial economic benefits as well.

### TECHNICAL FIELD

The utility model relates to the field of cakes, and more particularly relates to a scene cake capable of being transported remotely, and can be produced in batches and can be stored for a long time.

### BACKGROUND ART

Cake is one of food necessary for wedding, birthday, company banquet and other occasions.

The invention discloses a novel cake in patent number CN 201020678688.6, wherein the cake body is sequentially provided with a cream layer and a flour layer from top to bottom, wherein a chocolate layer is further arranged between the flour layer and the cream layer, an ice spraying layer is arranged on the cream layer. According to the novel practical cake, due to the arrangement of the ice spraying layer, the cake is cool and greasy, the chocolate layer is made to be more delicious.

The cake disclosed by the invention and the existing cake have following problems: Firstly, existing cakes, such as birthday cakes and wedding cakes, are not conducive to long-distance transportation because of their short shelf life. Therefore, they are purchased near the cake shop, and different cake shops have different pastry chefs. The artificially created scenes are inevitable. The difference in the craftsmanship of the pastry chefs is different. There is even a situation in which a scene can only be made by a particular pastry chef. This personalized cake does not have the possibility of finalization and standardization. Most importantly, the existing cake basically consists of a cake layer of cream layer and flour layer, and the cream layer is made up of various scenes by the pastry chef, such as various animals, various flowers, etc. This piece not only needs a pastry chef. Very professional level, and often use food coloring, causing safety hazards. Secondly, an existing candle is directly inserted into a cake, the candle oil in the ignition process of the candle directly falls on the cake, so that the candle oil is not safe to eat. In addition, the existing cake is integrally transported, due to the requirements of the edible life of the food and the food preservation temperature, the existing cake is not beneficial to long-distance transportation.

### SUMMARY OF THE UTILITY MODEL

The technical problem to be solved is to provide a novel scene cake, so that not only can the effect of a scene cake on the market can be achieved, and the technical problem that a scene part can be transported at a long distance and can be produced in batches and can be stored for a long time can be solved.

In order to solve the problem, the technical scheme of the invention is as follows: a novel scene cake, comprising:

a cake body, and

an isolation layer, and

a scene layer,

the cake body, the isolation layer and the scene layer can be independently detached, the isolating layer is arranged on the cake body in a cake using state, the scene layer is positioned on the isolation layer to form a complete cake.

In some embodiments, in a transportation state, the cake body is formed by wrapping a cold storage package body conforming to long-distance transport requirements of cake food materials.

In some embodiments, wherein the scene layer comprises a scene part and a decoration part composed of a plurality of decoration units, the decoration part is arranged on the scene part.

In some embodiments, the scene part is integrally formed and made of food-grade PVC or ABS, and a containing space for containing a music device is formed in the scene part, a triggering part is arranged on the scene part, and the triggering part is connected with the music device.

In some embodiments, the decoration part is detachably arranged on the scene part, or the decoration part is fixedly arranged on the scene part.

In some embodiments, wherein a groove is formed in the decoration unit, and a protruding part matched with the groove is arranged on the scene part, and the decoration unit is arranged on the scene part through the cooperation of the groove and the protruding part.

In some embodiments, a plurality of lamp bead installation positions capable of containing lamp beads are arranged on the surface of the scene part in advance in the mold opening process, and a wiring groove for wiring of the lamp bead and a space for installing the power supply module are formed in the bottom of the scene part, and the lamp beads are installed on the scene part through the lamp bead installation positions, and the connecting line of the lamp bead is connected with the power supply module through the wiring groove.

In some embodiments, the isolation layer comprises isolation paper, and the isolation paper comprises upper isolation paper laid on the upper surface of the cake body, and/or side isolation paper coated on the side surface of the cake body.

In some embodiments, the cake body is selected from a sponge cake, a chiffon cake, a swan cake and a heavy oil cake, a cheese cake, a mousse cake and an ice cream cake, wherein the cake body consists of one or more layers of food material layers,

The cake body comprises:

a cake embryo, wherein the cake embryo is rapidly frozen in a cold storage, with freezing temperature from 20 DEG c. to 40 DEG c., and the freezing time from 1 hour to 1.5 hours, and

a packaging bag, wherein the packaging bag is attached to the surface of the cake embryo, and

a packaging box and an outer bag, which are arranged outside the packaging bag.

The invention further provides a novel scene cake, comprises:

a cake body and a scene layer,

wherein the scene layer comprises a scene part which is integrally formed and a decoration part which is composed of a plurality of decoration units, wherein the cake body comprises one or more layers of food material layers which are rapidly frozen and are coated with vacuum packaging, the cake body, the scene part and the decoration part can be independently detached,

the scene part is arranged on the cake body in a cake using state, the decoration unit can be placed on the scene part to form a complete scene cake.

In some embodiments, a containing space for containing the music device is formed in the bottom of the scene part, a triggering part is arranged on the scene part, and the triggering part is connected with the music device.

In some embodiments, a plurality of lamp bead installation positions capable of containing lamp beads are arranged on the surface of the scene part in advance in the mold opening process, and a wiring groove for wiring of the lamp bead and a space for installing the power supply module are formed in the bottom of the scene part, and the lamp beads are installed on the scene part through the lamp bead installation positions, and the connecting line of the lamp bead is connected with the power supply module through the wiring groove.

With the adoption of the above technical solution, the utility model has the following advantages and positive effects as compared with the prior art:

the cake body, the isolation layer and the scene layer can be independently detached, and all the components can be independently packaged and transported independently; the cake body is separated from the scene layer, so that potential safety hazards caused by food coloring are avoided. In the transportation state, the cake body is formed by wrapping a cold storage package body conforming to the long-distance transport requirements of cake food materials, and the shelf life is long; the scene layer is various models including toys, and the shelf life is not limited by the shelf life, after the cake is eaten, the scene layer can be used as a souvenir for long-term collection, and standardized batch production can be carried out on classic scenes commonly favored by consumers; by assembling the scene layer, as well as the lighting and vocal music on the scene layer, it can increase the sense of participation, the excitement of the birthday and the festive atmosphere; and the cake body consisting of the refrigerated package that meets the long-distance transportation requirements of the cake ingredients, combined with standardized production of the scene module is beneficial to the promotion of the commercialization of the scene cake of the utility model, and has certain commercial economic benefits.

The isolating layer is arranged on the upper surface of the cake body, so that direct contact between the scene layer and the cake body is avoided, the candle can be arranged on the upper surface of the scene layer, so that the candle oil can be prevented from falling on the cake directly.

The whole cake body is covered by the isolation paper, so that the pollution on the side surface of the cake body is effectively prevented.

The decorating part of the scene cake is made of PVC/ABS materials and has no peculiar smell, non-toxic and environment-friendly, and a food-grade PVC (polyvinyl chloride) with the European Union environment-friendly requirement is generally selected in the industry.

### BRIEF DESCRIPTION OF THE DRAWINGS

Combined with the drawings and the detailed description, the utility model will be further described in detail.

FIG. 1 is a schematic diagram of a cross section of a scene cake provided by the utility model,

FIG. 2 is a schematic structural diagram of a scene cake provided by the utility model,

FIG. 3 is a schematic structural diagram of a scene cake provided by the utility model,

FIG. 4(a) is a schematic diagram of a lower surface structure of a scene part provided by the utility model, FIG. 4(b) is a schematic diagram of a side surface structure of a scene part provided by the utility model,

FIG. 5 is a schematic structural diagram of the upper surface of a scene part provided by the utility model,

FIG. 6 is a schematic diagram of the scene layer of FIG. 2,

FIG. 7 is a schematic diagram of the scene layer of FIG. 3,

FIG. 8 is a schematic diagram of the scene layer substrate of FIG. 3,

FIG. 9 is a schematic diagram of the cartoon model of FIG. 3,

FIG. 10 is a schematic diagram of connection between a scene layer substrate and a cartoon model provided by the utility model,

FIG. 11 is a schematic diagram of an embodiment of the utility model.

FIG. 12 is a schematic diagram of another embodiment of the utility model.

1—cake body,

2—isolation paper,

3—isolation plate,

4—scene layer, 41—scene part, 42-—decoration part, 4201-—protruding part, 4101—groove,

411—installation space, 412—sound transmission holes, 413—power supply module,

414—lamp bead installation positions,

5—candle inserting holes.

### DETAILED DESCRIPTION OF THE PREFERRED EMBODIMENTS

The novel scene cake provided by the utility model is further described in detail with reference to the accompanying drawings and the specific embodiments. The advantages and features of the present utility model will become apparent from the following description and claims. It should be noted that the drawings are in a simplified form and have a non-precise ratio, so that the purpose of describing the embodiment of the utility model can be conveniently and clearly demonstrated.

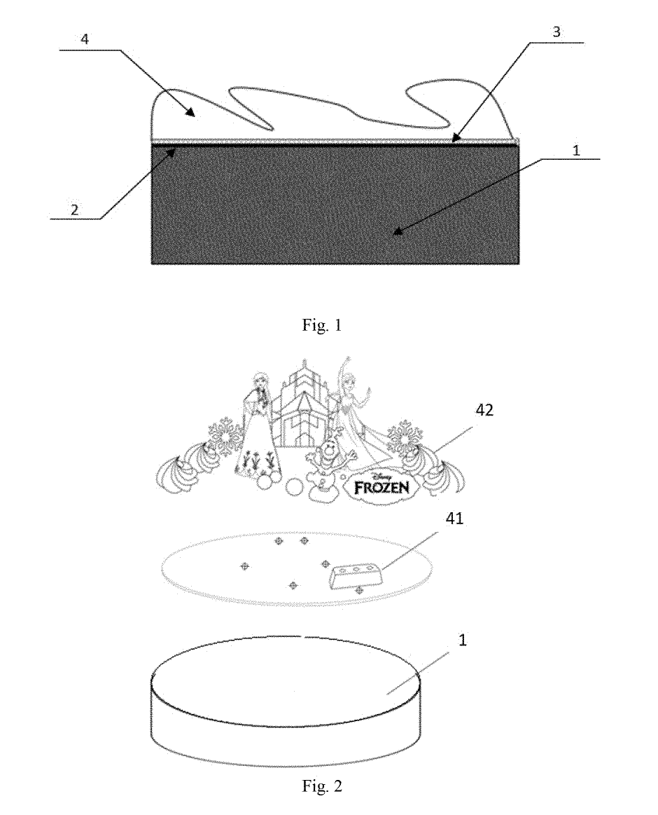

Referring to FIG. 1, the novel scene cake provided by the utility model comprises a cake body 1, an isolation layer and a scene layer 4, wherein the cake body 1, the isolation layer and the scene layer 4 can be independently detached,

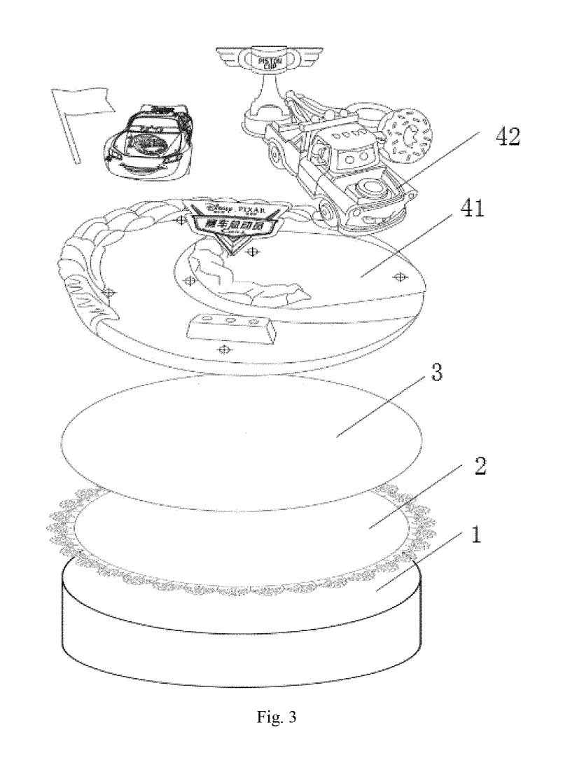

referring to FIG. 3, in the cake using state, the isolation layer is arranged on the cake body 1, the scene layer 4 is positioned on the isolation layer to form a complete cake.

In the transportation state, the cake body 1 is formed by wrapping a cold storage package, conforming to the long-distance transport requirements of cake food materials, and has a relatively long preservation period and a long shelf life.

Referring to FIGS. 7-9, the scene layer 4 comprises a scene part 41 and a decorative part 42 composed of a plurality of decoration units, the decoration part is arranged on the scene part. The decoration unit can comprise various models including toys. Of course, in order to have the overall attractiveness after the scene layer 4 is placed on the cake body 1, and the bottom shape of the scene part 41 can be set to be consistent with the shape of the upper surface of the cake body 1. The shape is consistent, meaning that the size and the geometric shape are approximately the same. The shape of the upper scene of the scene part 41 is a regular shape or an irregular shape, as long as the scene effect which is presented by the color and shape thereof is matched with the scene consisted by the models of the decoration part of the scene part, and forming a more aesthetic cake scene. In the embodiment, the cake is a total mobilization cake of a racing car, and the scene part 41 is of an irregular shape, and comprises a flat runway and raised mountain peaks, the decoration part 42 comprises a toy car, a trophy cup, tires and the like.

The scene part 41 is made of food-grade PVC (polyvinyl chloride) or ABS (acrylonitrile butadiene styrene), the isolation layer can also be made of food-grade PVC (polyvinyl chloride) or ABS (acrylonitrile butadiene styrene) materials.

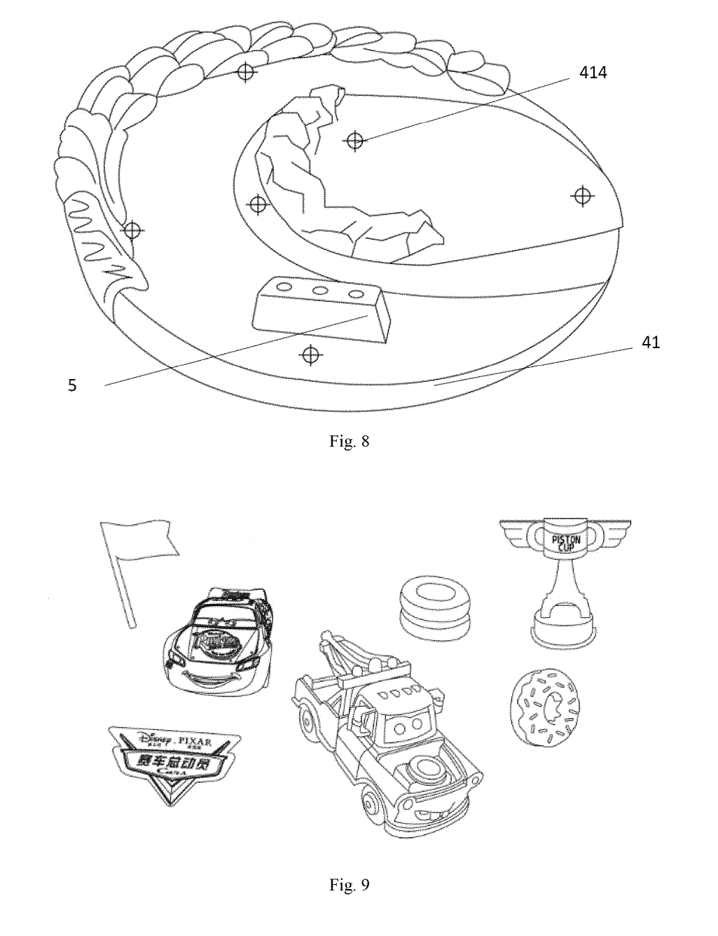

In a specific embodiment, as shown in FIG. 8 and FIG. 9, the decoration part 42 is detachably arranged on the scene layer substrate, the decoration part 42 and the scene layer substrate are arranged separately, on one hand, the scene layer is easier to package, and the size of the package is smaller, and the method is more suitable for batch production, on the other hand, by splicing the scene layer, the hand feeling and the fun can be increased.

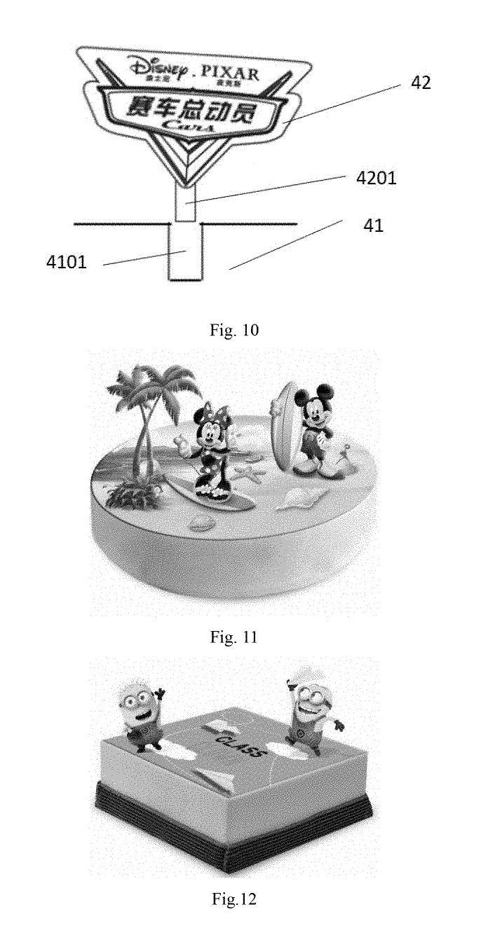

Specifically, referring to FIG. 10, the cartoon model of the decoration part 42 is provided with a protruding part 4201, a groove 4101 matched with the protruding part 4201 is formed in the scene part 41, the decoration part 42 is arranged on the scene part 41 through the matching of the protruding part 4201 and the groove 4101, the detachable connection mode is not limited thereto, a groove is formed in the decoration part 42, and a protruding part is arranged on the scene part, or the detachable connection mode between the decoration part 42 and the scene part is a detachable connection mode in the prior art, such as buckle type connection, adhesive pasting, magnetic pasting and the like. Certainly, in a specific embodiment, the decoration part 42 can also be fixedly arranged on the scene part.

In a specific embodiment, the upper surface of the scene layer can be made of a flexible food-grade material, so that the scene layer has the texture of the cake, and the decoration part 42 can be directly inserted into the scene layer.

The cake body 1 is separated from the scene layer 4, so that potential safety hazards caused by food coloring are avoided. The isolation layer can be made of food-grade materials, and the scene layer 4 can be made of food-grade PVC (polyvinyl chloride) or ABS (acrylonitrile butadiene styrene) plastic, and the quality is relatively light, the scene layer 4 is various models including toys, and is not limited by the shelf life, after the cake is eaten, the scene layer can be used as a souvenir for long-term collection, and standardized batch production can be carried out on classic scenes commonly favored by consumers, in a transportation state, the cake body 1 is formed by wrapping a cold storage packaging body which meets the requirement for long-distance transportation of cake food materials, and the shelf life is long, and the cake body 1 is formed by arranging a cold storage package which meets the requirement for long-distance transportation of cake food materials, in combination with a standardized production scene module. The method is beneficial to commercial popularization of the practical novel scene cake, and has certain commercial economic benefits.

The isolation layer is arranged on the upper surface of the cake body, so that direct contact between the scene layer 4 and the cake body 1 is avoided, and the candle can be ignited on the upper surface of the scene layer 4, and the candle oil is prevented from directly falling on the cake.

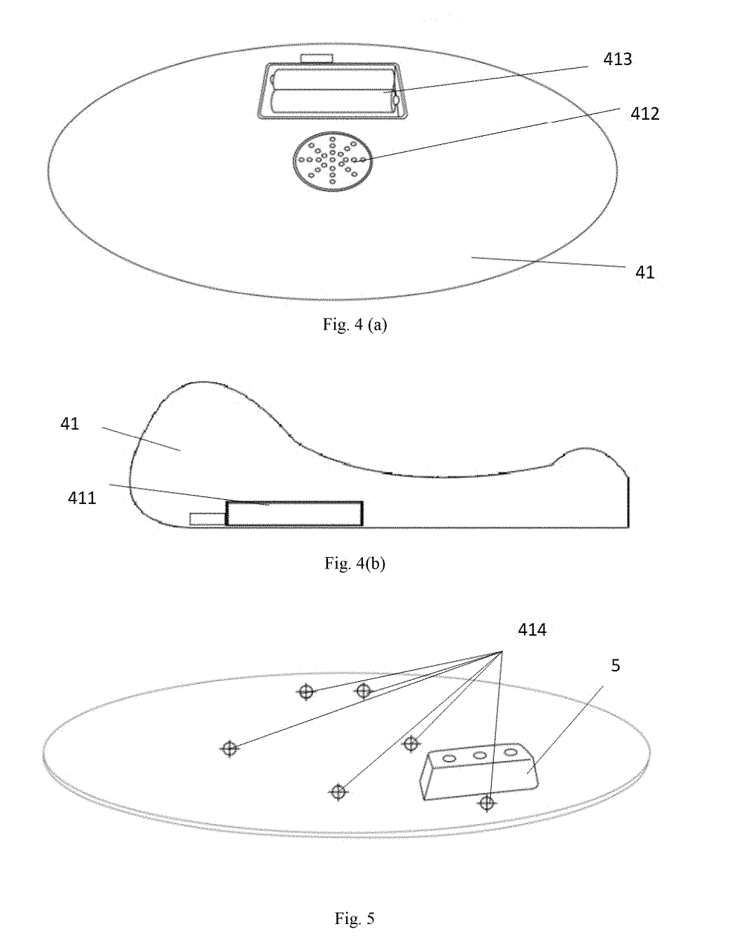

Referring to FIG. 4(a) and FIG. 4(b), in a specific embodiment, a containing space 411 for containing a music device is formed in the scene part 41, a triggering part is arranged on the scene part 41, and the triggering part can be arranged at any position of the scene part 41, such as a bottom face, a side face and the like, and the triggering part is connected with the music device. Optionally, a plurality of sound transmission holes 412 can be formed in the bottom surface of the scene part 41 corresponding to the music device.

In a specific embodiment, referring to FIG. 5, a plurality of lamp bead installation positions 414 capable of containing the lamp beads are arranged on the surface of the scene part in advance in the mold opening process, and a wiring groove for wiring of the lamp bead and a space for installing the power supply module 413 are formed in the bottom of the lamp bead, and the lamp beads are mounted on the scene part through the lamp bead installation positions 414, and the connecting line of the lamp bead is connected with the power supply module 413 through the wiring groove. In order to save space, the power supply and the switch of the lamplight device can be arranged to share the same power supply with the music device, the power supply of the music device can also share the power supply module 413 of the lamp bead.

Referring to FIG. 1, the isolation layer comprises isolation paper 2, and the isolation paper 2 is spread on the upper surface of the cake body 1.

In a particular embodiment, the isolation paper includes upper isolation paper flatly spread across the upper surface of the cake body 1, and side isolation paper covering the side face of the cake body 1, the whole cake body 1 is covered with the isolating paper 2, and the whole cake body 1 is covered with the isolating paper 2, so that the pollution on the side surface of the cake body 1 is effectively prevented. Optionally, the overall attractiveness and the ornamental value of the cake are achieved, pictures related to scenes of the scene layer can be printed on the isolation paper on the side face of the cake body, and the isolation bottom plate 3 can also be arranged, the isolation plate 3 is placed on the upper surface of the isolation paper 2, a scene layer 4 is arranged on the isolation plate 3, and the isolation plate 3 is used for bearing the weight of the scene layer 4

The cake body 1 is selected from a sponge cake, a chiffon cake, a swan cake and a heavy oil cake, a cheese cake, a mousse cake and an ice cream cake, wherein the cake body consists of one or more layers of food material layers. The raw materials and the form of the cake body 1 adopt raw materials and forms of cakes in the prior art. After the food material of the cake body 1 is manufactured, the cake body 1 is placed in a cold storage for rapid freezing, the rapid freezing temperature ranges from 20 DEG c. to 40 DEG c., and the quenching time ranges from 1 hour to 1.5 hours, and a packaging bag is arranged outside the cake embryo, air in the packaging bag is drawn out through a vacuum machine, and the packaging bag is attached to the surface of the packaging bag; and a packaging box and an outer bag which are vacuumized are arranged outside the packaging bag.

In a specific embodiment, a candle is arranged on the scene layer 4. An isolation layer is arranged on the upper surface of the cake body 1, and direct contact between the scene layer 4 and the cake body 1 is avoided, the candle is arranged on the upper surface of the scene layer 4, and the candle oil is prevented from falling on the cake directly. Specifically, the candle inserting holes 5 can be formed in the upper surface of the scene layer substrate, and optionally, a boss is arranged at a position close to the edge of the upper surface of the scene layer substrate, a plurality of holes are formed in the boss and serve as candle inserting holes 5, and the candle inserting holes 5 are used for inserting a candle; and the boss can be fixedly arranged on the scene layer substrate, can also be arranged on the scene layer substrate in an inserting connection mode similar to the cartoon model.

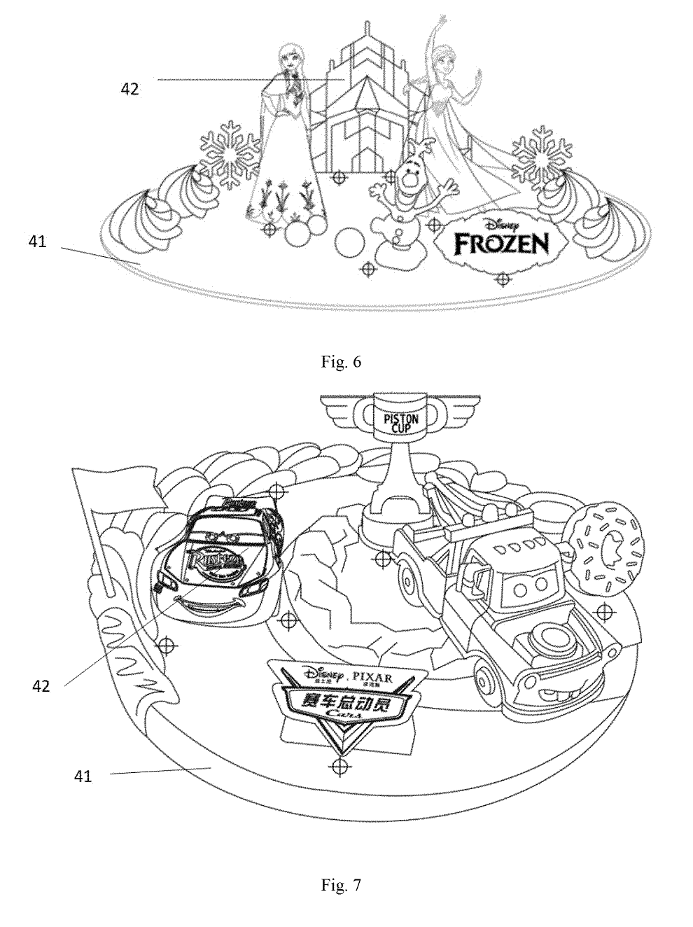

In a specific embodiment, referring to FIG. 2 and FIG. 6, a cake body 1 and a scene layer 4, wherein the cake body 1 and the scene layer 4, wherein the scene layer 4 comprises a scene part 41 and a decoration part 42, wherein the scene part 41 is integrally manufactured, and the decoration part 42 is composed of a plurality of decoration units, the cake body 1 comprises one or more layers of food material layers which are rapidly frozen and are coated with vacuum packaging, the cake body 1, the scene part 41 and the decoration part 42 can be independently detached,

The scene part 41 is arranged on the cake body 1 in a cake using state, the decoration unit of the decoration part 42 can be placed on the scene part 41 to form a complete scene cake.

In the embodiment, the bottom surface of the scene part 41 is made of a food-grade material, and the cake body does not pollute the cake body 1, the surface of the cake is smooth, the force on the surface of the cake is more uniform, so the influence on the shape of the cake is avoided.

In a specific embodiment, referring to FIG. 4(a) and FIG. 4(b), a containing space 411 for containing the music device is formed in the bottom of the scene part 41, a triggering part is arranged on the scene part 41, and the triggering part is connected with the music device.

In one embodiment, a plurality of lamp bead installation positions 414 capable of containing lamp beads are arranged on the surface of the scene part 41 in advance in the mold opening process, and a wiring groove for wiring of the lamp bead and a space for installing the power supply module are formed in the bottom of the scene part 41, and the lamp beads are installed on the scene part 41 through the lamp bead installation positions 414, and the connecting line of the lamp bead is connected with the power supply module 413 through the wiring groove.

Referring to FIG. 11, in a specific embodiment, the cake is Mickey Mouse and Minnie Mouse vacation scene cake.

Referring to FIG. 12, in a specific embodiment, the cake is Minions flying paper airplane scene cake.

The embodiments of the utility model are described in detail above with reference to the drawings, but the utility model is not limited to the above-described embodiments. Even though various changes are made to the invention, the changes belong to the scope of the claims of the invention and the equivalent technology thereof, the protection scope of the invention still falls within the protection scope of the invention.

1. A novel scene cake, comprising:
a cake body, and an isolation layer, and a scene layer, the cake body, the isolation layer and the scene layer can be independently detached, the isolating layer is arranged on the cake body in a cake using state, the scene layer is positioned on the isolation layer to form a complete cake.

2. The novel scene cake of claim 1, wherein the cake body is formed by wrapping a cold storage package body conforming to long-distance transport requirements of cake food materials in a transportation state.

3. The novel scene cake of claim 1, wherein the scene layer comprises a scene part and a decoration part composed of a plurality of decoration units, the decoration part is arranged on the scene part.

4. The novel scene cake of claim 3, wherein the scene part is integrally formed and made of food-grade PVC or ABS, and a containing space for containing a music device is formed in the scene part, a triggering part is arranged on the scene part, and the triggering part is connected with the music device.

5. The novel scene cake of claim 3, wherein the decoration part is detachably arranged on the scene part, or the decoration part is fixedly arranged on the scene part.

6. The novel scene cake of claim 5, wherein a groove is formed in the decoration unit, and a protruding part matched with the groove is arranged on the scene part, and the decoration unit is arranged on the scene part through the cooperation of the groove and the protruding part.

7. The novel scene cake of claim 3, wherein a plurality of lamp bead installation positions capable of containing lamp beads are arranged on the surface of the scene part in advance in the mold opening process, and a wiring groove for wiring of the lamp bead and a space for installing the power supply module are formed in the bottom of the scene part, and the lamp beads are installed on the scene part through the lamp bead installation positions, and the connecting line of the lamp bead is connected with the power supply module through the wiring groove.

8. The novel scene cake of claim 1, wherein the isolation layer comprises isolation paper, and the isolation paper comprises upper isolation paper laid on the upper surface of the cake body, and/or side isolation paper coated on the side surface of the cake body.

9. The novel scene cake of claim 1, wherein the cake body is selected from a sponge cake, a chiffon cake, a swan cake and a heavy oil cake, a cheese cake, a mousse cake and an ice cream cake, and the cake body consists of one or more layers of food material layers;
the cake body comprises:
a cake embryo, the cake embryo being rapidly frozen in a cold storage, with freezing temperature from 20 DEG c. to 40 DEG c., and the freezing time from 1 hour to 1.5 hours;
a packaging bag, the packaging bag being attached to the surface of the cake embryo, and a packaging box and an outer bag, which are arranged outside the packaging bag.

10. A novel scene cake, comprises:
a cake body and a scene layer, wherein the scene layer comprises a scene part which is integrally formed and a decoration part which is composed of a plurality of decoration units, the cake body comprises one or more layers of food material layers which are rapidly frozen and are coated with vacuum packaging, the cake body, the scene part and the decoration part can be independently detached, the scene part is arranged on the cake body in a cake using state, the decoration unit can be placed on the scene part to form a complete scene cake.

11. The novel scene cake of claim 10, wherein a containing space for containing the music device is formed in the bottom of the scene part, a triggering part is arranged on the scene part, and the triggering part is connected with the music device.

12. The novel scene cake of claim 10, wherein a plurality of lamp bead installation positions capable of containing lamp beads are arranged on the surface of the scene part in advance in the mold opening process, and a wiring groove for wiring of the lamp bead and a space for installing the power supply module are formed in the bottom of the scene part, and the lamp beads are installed on the scene part through the lamp bead installation positions, and the connecting line of the lamp bead is connected with the power supply module through the wiring groove.
